(19) United States
(12) Patent Application Publication
(10) Pub. No.: US 2018/0313280 A1
(43) Pub. Date: Nov. 1, 2018

(54) METHOD FOR IGNITING GASEOUS FUELS IN ENGINES

(71) Applicant: Caterpillar Inc., Peoria, IL (US)

(72) Inventor: Charlie Chang-Won Kim, Dunlap, IL (US)

(73) Assignee: Caterpillar Inc., Peoria, IL (US)

(21) Appl. No.: 15/582,852

(22) Filed: May 1, 2017

(51) Int. Cl. F02D 41/00; F02M 25/10; F02M 21/02; F02M 31/20; F01L 1/344

(52) U.S. Cl. CPC F02D 41/0027; F02M 25/10; F02D 2200/021; F02M 31/205; F01L 1/344; F02M 21/0215

(57) ABSTRACT

A method to ignite a gaseous fuel in an engine of an engine system is disclosed. The method includes introducing a compound having a peroxide group into a main combustion chamber of the engine for igniting the gaseous fuel. Further, the method includes controlling, by a controller, one or more parameters of the engine system to attain a temperature in the main combustion chamber within a temperature range. The compound decomposes into a radical, thus facilitating ignition of the gaseous fuel.

### TECHNICAL FIELD

The present disclosure relates to a method for igniting gaseous fuels in internal combustion engines. More particularly, the present disclosure relates to igniting gaseous fuels by use of a compound that has a peroxide group.

### BACKGROUND

Internal combustion engines are commonly applied as prime movers in a variety of applications and environments. Over the years, numerous attempts have been made to reduce emissions and to improve efficiency of such engines. For example, engine manufacturers and operators have proposed the need to combust leaner air-fuel mixtures for efficiency and use exhaust gas recirculation (EGR) to reduce emissions such as of Nitrogen Oxides (NOx).

During high EGR and/or when applying relatively leaner air-fuel mixtures, for example, associated ignition systems generally find it difficult to provide a stable, consistent combustion of the air-fuel mixture. For effective combustion in such situations, engines are required to have suitable provisions that facilitate adequate ignition. However, several of the currently available engines lack such provisions, and the engines that do, incorporate encapsulated spark plugs or pre-chamber engine designs with or without fuel enrichment or purging that help achieve a more robust and consistent ignition phenomenon. However, the use of such encapsulated spark plugs and/or pre-chamber designs may require additional NOx treatment to meet stringent emission regulations. Moreover, such encapsulated spark plugs and/or pre-chamber engine designs are subjected to relatively high operational temperature conditions, during engine operations that shorten the life of the encapsulated spark plugs and/or the pre-chamber engine designs.

U.S. Pat. No. 7,493,886 relates to a controlled initiation and augmentation of the combustion of hydrogen, alcohol, and hydrocarbon fuels, and fuel/aqueous-fuel combinations in an engine, through the use of select radical ignition species. Radical ignition species may include H₂O₂ (hydrogen peroxide) and HO₂ (the hydroperoxyl radical) for hydrogen, hydrocarbon and alcohol fuels and fuel/aqueous-fuel mixtures. The radical ignition species are generated in at least one prior combustion cycle in a secondary chamber associated with the main combustion chamber of the engine.

### SUMMARY OF THE INVENTION

In one aspect, a method to ignite a gaseous fuel in an engine of an engine system is disclosed. The method includes introducing a compound having a peroxide group into a main combustion chamber of the engine for igniting the gaseous fuel. Further, the method includes controlling, by a controller, one or more parameters of the engine system to attain a temperature in the main combustion chamber within a temperature range. The compound decomposes into a radical, thus facilitating ignition of the gaseous fuel.

In another aspect, the disclosure relates to an engine system. The engine system includes a main combustion chamber and a controller. The main combustion chamber is adapted to receive a compound having a peroxide group for igniting a gaseous fuel. The controller is configured to control one or more parameters of the engine system to attain a temperature in the main combustion chamber within a temperature range. The compound decomposes into a radical within the temperature range and facilitates ignition of the gaseous fuel.

In yet another aspect, the present disclosure is directed towards a method for operation of a natural gas engine of a natural gas engine system. The method includes introducing hydrogen peroxide (H₂O₂) into a main combustion chamber of the natural gas engine for igniting natural gas. Further, the method includes controlling, by a controller, one or more parameters of the natural gas engine system to attain a temperature in the main combustion chamber within a temperature range of 900 Kelvin to 1000 Kelvin. The H₂O₂ decomposes into a hydroxyl (OH) radical within the temperature range, facilitating ignition of the natural gas.

### BRIEF DESCRIPTION OF THE DRAWINGS

FIG. 1 is a schematic view of an engine system, in accordance with an aspect of the present disclosure;

FIG. 2 is a graphical representation illustrating a time and a temperature at which a combustion within a main combustion chamber of the engine system may occur, in accordance with an aspect of the present disclosure; and

FIG. 3 is a flowchart illustrating an exemplary method for operation of an engine of the engine system, in accordance with an aspect of the present disclosure.

### DETAILED DESCRIPTION

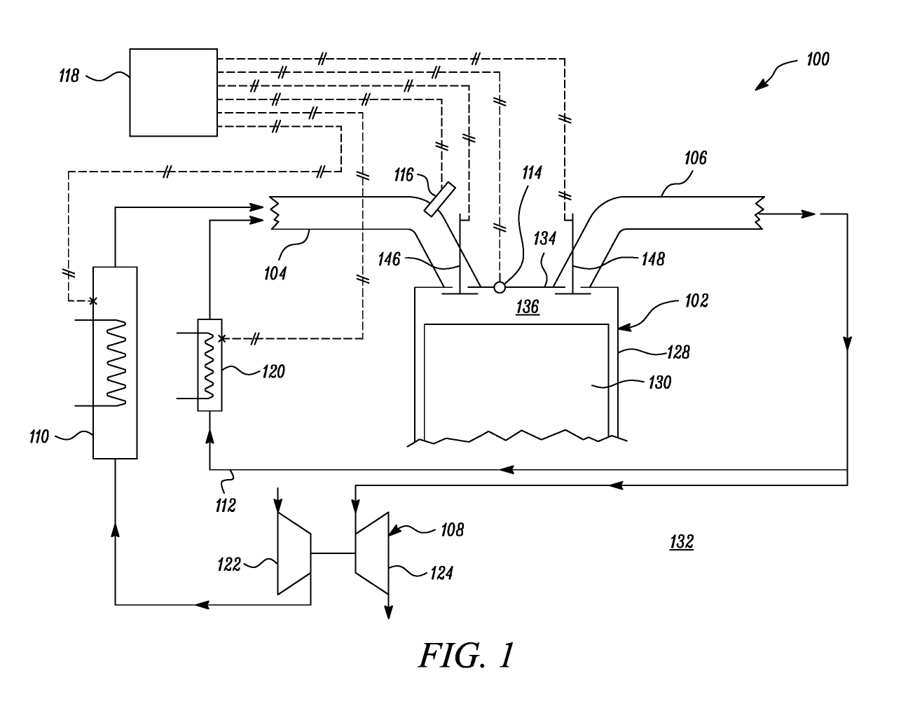

Referring to FIG. 1 an engine system 100 is illustrated. The engine system 100 may be applied in a variety of machines, such as, but not limited to, excavators, loaders, dozers, compactors, paving machines, draglines, off-highway trucks, mining trucks, locomotives, and similar other machines, such as those that are applicable in a construction industry. In some implementations, aspects of the present disclosure may be extended to stationary power generating machines, and to machines that are applied in commercial and domestic environments. The engine system 100 includes an engine 102, an intake manifold 104, an exhaust manifold 106, a turbocharger 108, an intercooler 110, an exhaust gas recirculation (EGR) circuit 112, a sensor 114, an injector 116, and a controller 118. The turbocharger 108 further includes a compressor 122 and a turbine 124.

The engine 102 may be a natural gas engine that is configured to receive a gaseous fuel, such as natural gas, (e.g. having methane (CH₄)), for combustion. In one implementation, therefore, the engine system 100 may be a natural gas engine system. Optionally, the engine 102 may use propane gas, hydrogen gas, or any other suitable gaseous fuel, singularly or in combination with each other or with natural gas, to power the engine's operation. Alternatively, the engine 102 may be based on a dual-fueled engine system. The engine 102 may embody a V-type, an in-line, or a varied configuration as is conventionally known. The engine 102 is a multi-cylinder engine, although aspects of the present disclosure are applicable to engines with a single cylinder as well. Further, the engine 102 may be one of a two-stroke engine, a four-stroke engine, or a six-stroke engine. Although these configurations are disclosed, aspects of the present disclosure need not be limited to any particular engine type.

The engine 102 includes a cylinder 128, and a piston 130 that may reciprocate within the cylinder 128. Although a single cylinder 128 is shown, the engine 102 may include multiple cylinders. The cylinder 128 may include a cylinder head 134, and the engine 102 may define a main combustion chamber 136 within the cylinder 128, between the piston 130 and the cylinder head 134. Further, the piston 130 may follow a 4-stroke working principle within the cylinder 128, according to a general practice of the art. Other working principles may however be contemplated.

The injector 116 is configured to inject the gaseous fuel into the intake manifold 104 of the engine 102. Alongside an injection of a gaseous fuel, the injector 116 may be also configured to inject an amount of a compound, having a peroxide group, into the intake manifold 104, and thus into the main combustion chamber 136 of the engine 102. The compound facilitates ignition of the gaseous fuel within the main combustion chamber 136 at a temperature that is within a temperature range. For example, the temperature range is defined between 900 Kelvin and 1000 Kelvin. More particularly, the compound decomposes into a radical, such as hydroxyl (OH) radical, within said temperature range, facilitating a break down and an ignition of the gaseous fuel. In an example, the compound is Hydrogen Peroxide (H₂O₂).

In one implementation, it is possible that the compound and the gaseous fuel may be introduced into the intake manifold 104 (or the main combustion chamber 136) one after the other. For example, it is possible for an injection of the gaseous fuel to occur prior to the introduction of the compound into the main combustion chamber 136, although conversely, the compound may be introduced first and then a fuel injection may follow. It is also possible that the compound and the gaseous fuel be introduced simultaneously, such as when the two are received by the injector 116, and are then homogenously mixed before being introduced into the intake manifold 104 (or to the main combustion chamber 136). In some embodiments, a homogenous mixing of the compound with the gaseous fuel may occur before the compound and the fuel reach the injector 116. For example, a mixing chamber positioned upstream of the injector 116 may facilitate such a mixing. In yet some embodiments, a mixing of the gaseous fuel and the compound may be performed within the injector 116. In still other embodiments, the gaseous fuel and the compound is homogenously mixed once introduced within the intake manifold 104 (or into the main combustion chamber 136). A mixture of the gaseous fuel and the compound may be defined as a fuel charge.

According to an exemplary depiction of an injector placement in FIG. 1, the injector 116 is positioned within the intake manifold 104 of the engine 102. Nevertheless, other positions of the injector 116, such as a position within the main combustion chamber 136, may be contemplated. In one example, the injector 116 may be assembled into the cylinder head 134, and the injector's tip (or nozzle) may be extended into the main combustion chamber 136 so as to facilitate injection. In some examples, an injector adapted to deliver the gaseous fuel may differ and/or be separate from an injector that is adapted to deliver the compound.

In an embodiment, the injector 116 may be positioned at the compressor 122's inlet. In yet some further examples, there may be two injectors—one located at the compressor 122's inlet for injecting the gaseous fuel at the compressor 122's inlet, and the other located in the intake manifold 104 for injecting the compound into the intake manifold 104. Conversely, it is also possible that an injector for the gaseous fuel be located in the intake manifold 104, while an injector for the compound be located at the compressor 122's inlet.

The injector 116 may be configured to receive an amount of the gaseous fuel from a fuel tank (not shown), while the injector 116 may also be configured to receive an amount of the compound from a compound reservoir (not shown). A dedicated fuel line may be arranged between the fuel tank and injector 116 to facilitate fuel flow from the tank to the injector 116. Similarly, a dedicated line may be arranged between the compound reservoir and the injector 116 to facilitate compound flow from the compound reservoir to the injector 116. It is possible for these lines to include valves (not shown) that help regulate a flow of the fuel and/or the compound, respectively, to the injector 116.

In one embodiment, it is possible that the injector 116 injects or introduces an amount of the compound into the intake manifold 104, and the main combustion chamber 136 may receive the compound, such that the amount of the compound is a percentage of a combined amount of the compound and the gaseous fuel. In one example, the percentage is a predefined percentage. In yet another example, the percentage is 5%.

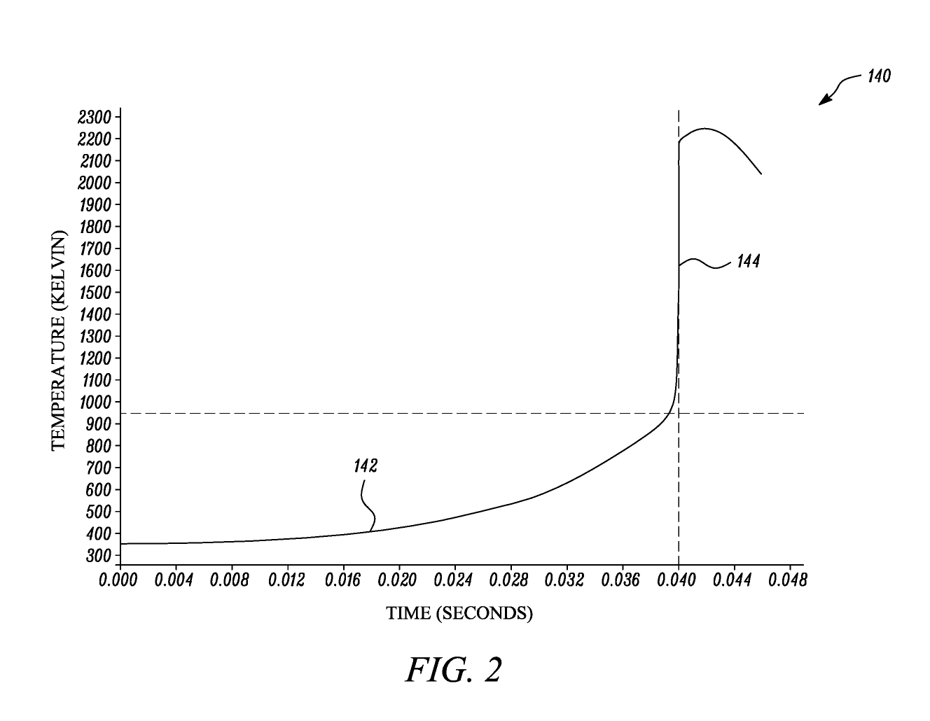

Referring to FIG. 2, a graphical representation 140 is provided that illustrates an exemplary profile of a curve 142, which represents a progressive state of a compound-gaseous fuel mixture (fuel charge) in the main combustion chamber 136, relative to temperature and time. A mixture of the fuel charge with an incoming compressed air from the compressor 122 may be referred to as an air-fuel mixture, and such an air-fuel mixture may include an air-fuel ratio. In the depicted embodiment of the curve 142, the compound is 5% of the combined amount of the compound and the gaseous fuel introduced into the main combustion chamber 136. Understandably, in such a case, the percentage of the gaseous fuel will form the remaining 95% of the combined amount of the compound and the gaseous fuel introduced into the main combustion chamber 136. In such a case, and as may be noted from the graphical representation 140, an ignition of the gaseous fuel is attained at 0.04 seconds from a start of injection of the mixture. As may also be noted, the ignition of the gaseous fuel is depicted by a steep rise in a slope of the curve 142 (see curve portion 144). Also, it may be noted that the curve portion 144 indicates a spike in temperature from an approximate value of 950 Kelvin to an approximate value of 2200 Kelvin. It will be appreciated that this graphical representation 140, and one or more values disclosed in relation to this representation, are based on a simulation data, and may change based on a variety of factors, such as including a rating and/or a quality of the gaseous fuel, and a percentage of the compound in the fuel charge. Further, a change in a slope of the curve 142 may be affected by an EGR rate through the EGR circuit 112 (or an internal EGR) as well as leaner conditions of the fuel charge, such as a leaner air-fuel mixture.

In some implementations, timings of combustion/ignition may need to be changed depending upon factors such as fuel type, engine compression ratio, engine displacement, engine speed, engine load or fuel rate, charge air temperature and pressure, engine operating environment, engine intake air flow rate, exhaust gas recirculation rate, fuel injection characteristics, engine coolant and lube temperatures, and other similar engine parameters. In one example, combustion/ignition may be set to occur slightly before a top dead center (TDC) of the cylinder 128 during a compression stroke of the piston 130 (see FIG. 1), for optimal work cycle efficiency. In one example, therefore, the amount of the compound (or a percentage of the compound) introduced into the main combustion chamber 136 may be progressively varied from a lesser amount to a higher amount to attain progressively shorter combustion timings of the gaseous fuel, as the engine 102 operates. For example, during an increase in a speed of the engine 102, quicker reaction times may be required between the gaseous fuel and the compound, and thus quicker combustion during work cycles. A progressive variation of the compound, and thus, an associated regulation of the percentage may be possible by controlling the valve that delivers the compound from the compound reservoir, for example. In one instance, if ignition of the gaseous fuel were minimally delayed and were required at 0.041 seconds from the start of injection, the amount of compound (i.e. the percentage) may be 0.5%, while if ignition of the mixture were required to be further delayed at 0.044 seconds from the start of injection, the amount of the compound (i.e. the percentage) may be further lessened and may be 0.01%. It may be noted that these values also relate to a simulation data, and thus may differ in certain applications. Therefore, these values may be seen as being purely exemplary in nature. In one further example, a maximum amount (or the higher amount) of the compound (i.e. a maximum percentage) required for ignition may be 5% of the combined amount of the compound and the gaseous fuel—this relation and related combustion timings have already been discussed alongside the graphical depiction of FIG. 2. In yet another example, for a given amount of the compound, (such as when an amount of the compound may remain constant during a work cycle of the engine 102), a load on the engine 102 may be controlled by changing an EGR rate and/or by changing the air-fuel ratio.

Referring back to FIG. 1, the sensor 114 may be accommodated within the cylinder head 134. In one example, the sensor 114 may be configured to detect a pressure condition within the cylinder 128, such as within the main combustion chamber 136, during engine operation. The sensor 114 may also be used to determine a pressure history within the main combustion chamber 136, and thus help compute a temperature within the main combustion chamber 136, at any given point in time. In one example, the sensor 114 may be in the form of a piezoelectric element disposed within the cylinder head 134. Such an element may include strain gauges or other known pressure sensitive devices, that react to a change in pressure in the main combustion chamber 136 and provide a signal indicative of said pressure.

The intake manifold 104 may be fluidly coupled to the compressor 122 of the turbocharger 108 to receive compressed air from the turbocharger 108. Since the intake manifold 104 may also accommodate the injector 116 of the engine system 100, a mixing of the air with the fuel charge may occur within the intake manifold 104. The exhaust manifold 106 may be configured to release residual products of such a combustion to an ambient 132 as exhaust gas. In the depicted embodiment, the exhaust gas is routed out to the ambient 132 through the turbine 124 of the turbocharger 108, and in that manner a flow of the exhaust gas may drive the turbine 124 during a passage of the exhaust gas through the turbine 124. A drive of the turbine 124 may facilitate a drive of the compressor 122, in turn enabling the compressor 122 to draw in air from the ambient 132, compress said air, and deliver the compressed air into the main combustion chamber 136, thus facilitating combustion.

Further, the engine 102 includes one or more valves. For example, the one or more valves include a first valve 146 and a second valve 148. In one implementation, the first valve 146 is an intake valve that may be adapted to regulate an entry of the air-fuel mixture into the main combustion chamber 136 from the intake manifold 104, while the second valve 148 may be adapted to regulate an exit of residual gases of combustion of air-fuel mixture out of the main combustion chamber 136 into the exhaust manifold 106. Although a single first valve 146 and a single second valve 148 is disclosed, multiple first valves and multiple second valves may be applied.

The intercooler 110 may be configured to cool an amount of compressed air delivered by the compressor 122 and enhance a volumetric efficiency of an intake air charge density. In some implementations, and as shown, the intercooler 110 may be located downstream to the compressor 122, so as to have the air compressed by the compressor 122 lose a portion of heat before entering the main combustion chamber 136.

The EGR circuit 112 facilitates a control or a reduction of the amount of oxides of nitrogen (NOx) emissions by quenching a temperature of combustion within the main combustion chamber 136. For example, the EGR circuit 112 introduces oxygen-poor exhaust gas into the main combustion chamber 136, thereby lessening the temperature and reducing NOx formation during combustion. The EGR circuit 112 may include an EGR cooler 120 to cool the exhaust gas introduced into the main combustion chamber 136. In some implementations, the EGR circuit 112 may be low pressure loop, a high pressure loop, an external or an internal EGR loop.

It may be noted that both the coolers (i.e. the EGR cooler 120 and the intercooler 110) may work on conventional heat exchange principles, and thus may be configured to cool a quantity of air (including exhaust gas passing through the EGR cooler 120) delivered to the main combustion chamber 136 for combustion. In one example, the coolers 110, 120 may have a stream of coolant flowing through a dedicated cooling circuit that may absorb heat from the associated media flowing through the coolers 110, 120 that need to be cooled. For instance, the associated media in the intercooler 110 may be the compressed air, and from the compressed air, heat may be absorbed by a coolant flowing through the intercooler 110. Similarly, the associated media in the EGR cooler 120 may be the exhaust gas that is routed back to the main combustion chamber 136 through the EGR circuit 112. From the exhaust gas, heat may be absorbed by a coolant that passes through the EGR cooler 120. In one implementation, a flow of coolants through each cooler 110, 120 may be powered by dedicated pumps (not shown). Additionally, each cooler 110, 120 may include a blower (not shown) to dissipate heat absorbed by the coolants to the ambient 132.

The controller 118 is configured to control one or more parameters of the engine system 100 to attain a temperature in the main combustion chamber 136 within a temperature range so that the injected compound decomposes into a radical within the temperature range. With the control of the parameters by the controller 118, and temperature attainment, the radicals facilitate an ignition of the gaseous fuel within the main combustion chamber 136. For example, the one or more parameters of the engine system 100 include an outlet temperature of the coolers 110, 120.

The controller 118 may be coupled with the injector 116 so that an injection of the compound-gaseous fuel mixture (i.e. the fuel charge) may be controlled by the controller 118. For example, the injection may be established by way of a solenoid valve action, or a needle valve action, available within the injector 116, as is well known, and it may be possible that the controller 118 be configured to vary such actions to vary an injection of fuel charge. It is also possible that the controller 118 be coupled to the valves that regulate the flow of gaseous fuel and the compound to the injector 116 in order to vary the percentage of the compound and the gaseous fuel in the fuel charge.

The controller 118 may be in electronic communication with the sensor 114 to receive a pressure signal, and thus deduce a temperature in the main combustion chamber 136. For example, the controller 118 may include a memory that may include a model or one or more predefined charts that may have values of temperature assigned against sensed pressure values provided by the sensor 114. Alternatively, a temperature in the main combustion chamber 136 may be deduced by analyzing an output temperature of the exhaust gas through the exhaust manifold 106. In such a case, and as with the embodiment noted above, the controller 118 may tally the output temperature against pre-stored temperature values in the memory of the controller 118, in turn helping deduce the temperature of the main combustion chamber 136. Alternatively, it is possible that the sensor 114 is a temperature sensor and the controller 118 determines the temperature of the main combustion chamber 136 by being in communication with such a temperature sensor positioned within the main combustion chamber 136, for example.

Further, the controller 118 may be in communication with the first valve 146, the second valve 148, the EGR cooler 120, and the intercooler 110, and may be configured to control one or more parameters of each of these elements/devices of the engine system 100 to attain a condition for combustion within the main combustion chamber 136.

In one implementation, the controller 118 is coupled to the pumps of the coolers so as to vary the pumping action of the coolants into one or more of the coolers 110, 120. For example, if it were deduced that the temperature of the main combustion chamber 136 is outside the temperature range (such as if the temperature exceeds the temperature range), the controller 118 may control the pumps to enhance a pumping action of the coolant, in turn facilitating a relatively cooled volume of compressed air and/or the exhaust gas to enter the main combustion chamber 136. In so doing, the temperature of the main combustion chamber 136 may be lowered to take a value within the temperature range, thus facilitating decomposition of the compound, of an injected fuel charge, into a radical, in turn facilitating the radical to break down the gaseous fuel so as to result in ignition of the gaseous fuel.

In some implementations, the controller 118 may be coupled to the blowers of the coolers 110, 120. In that manner, the controller 118 may vary a blower speed of the blowers to vary an outlet temperature of the coolers 110, 120, and thus meet the temperature requirement within the main combustion chamber 136 that is suited for combustion.

In other implementations, the controller 118 may be coupled to the first valve 146 and/or the second valve 148, and may vary openings/closures of the first valve 146 and/or the second valve 148 to maintain the temperature of the main combustion chamber 136 within the temperature range. For example, during or at an end of an exhaust stroke, the controller 118 may facilitate a delayed opening of the second valve 148, thus causing a delayed release of the exhaust gas from the main combustion chamber 136 into the exhaust manifold 106. The controller 118 may also facilitate a delayed opening of the first valve 146 so that there may be a delay in the receipt of the cooled compressed air/exhaust gas into the main combustion chamber 136. In so doing, a variation or a lowering of the temperature below the temperature range may be mitigated, and instead, the temperature may be maintained within the temperature range. Therefore, the one or more parameters of the engine system 100 may include a timing of opening and closing of the first valve 146 and the second valve 148.

In one implementation, the first valve 146 may be closed late and/or early during a work cycle to control a temperature in the main combustion chamber 136. Similarly, a re-opening and/or a closure of the second valve 148 may be varied to increase temperature and in-cylinder residuals. In such a case, a load change on the engine 102 may be achieved by use of an internal EGR, by reopening the second valve 148 when an exhaust pulse pressure is higher than an in-cylinder pressure.

The controller 118 may include power electronics, preprogrammed logic circuits, data processing circuits, associated input/output buses, volatile memory units, such as random access memory (RAM), non-volatile memory units, etc., to help process and store signals or data received from the sensor 114, for example. Such signals may be processed by a processor of the controller 118. The controller 118 may be a microprocessor based device, or may be implemented as an application-specific integrated circuit, or other logic device, which provide controller functionality, and such devices being known to those with ordinary skill in the art. In some implementations, the controller 118 may form a portion of one of the engine 102's electronic control unit (ECU), or may be configured as a stand-alone entity. Further, the controller 118 may include an analog to digital converter (not shown) that may be configured to receive and convert signals of pressure received from the sensor 114, for example, for a processing by the controller's processor.

### INDUSTRIAL APPLICABILITY

Instead of relying on thermal discharge/non-thermal discharge/laser ignition of gaseous fuel, aspects of the present disclosure disclose an exemplary method for operating the engine 102, and, more particularly, for igniting the gaseous fuel in the engine 102 by use of a compound. This compound may be introduced into the main combustion chamber 136 along with the introduction of the gaseous fuel. The compound has a peroxide group, and in one implementation, the compound is Hydrogen Peroxide (H₂O₂), as has been already noted above.

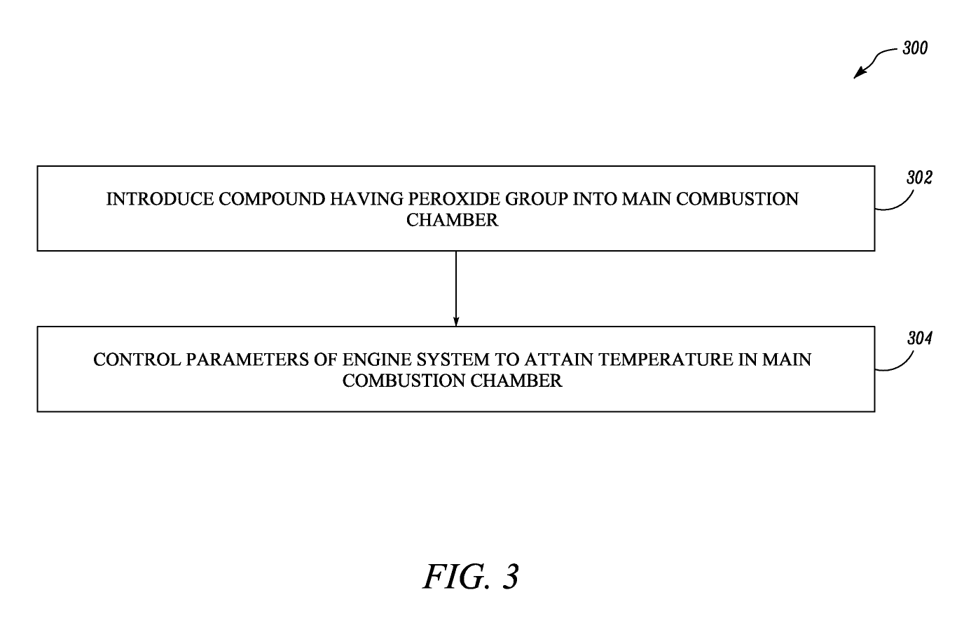

Referring to FIG. 3, this exemplary method is discussed. Notably, this exemplary method has been described by way of a flowchart 300 and is discussed in conjunction with FIGS. 1-2. The method starts at step 302.

At step 302, the compound is introduced into the main combustion chamber 136 of the engine 102 for igniting the gaseous fuel. The compound may be introduced into the main combustion chamber 136 as discussed earlier in the application. A percentage of the compound and a percentage of the gaseous fuel may be controlled by the controller 118. For doing so, the controller 118 may control the valves that transport the compound and/or the gaseous fuel to the injector 116, for example. Such a control may facilitate a variation in the combusting timings, as may be required during engine operations (see representations and discussions in and alongside FIG. 3 that pertain to an exemplary percentage of the compound, and which is set to meet an operational requirement of the engine 102). The method proceeds to step 304.

At step 304, the controller 118 controls one or more parameters of the engine system 100 to attain a temperature in the main combustion chamber 136 within a temperature range. As has been noted earlier in the application, an exemplary temperature range may be 900 Kelvin to 1000 Kelvin. The one or more parameters of the engine system 100 may include an outlet temperature of the coolers 110, 120. Although the EGR cooler 120 and the intercooler 110 is shown, it is possible that the controller 118 controls only one of the said coolers 110, 120 to control and maintain a temperature of the main combustion chamber 136. Further, the one or more parameters of the engine system 100 may include a timing of opening and closing of the first valve 146 and the second valve 148. By varying (or controlling) a timing of opening and closing of the valves 146, 148 a compression ratio of the engine 102 may be manipulated. For example, by controlling the first valve 146, an entrance of a portion of compressed air cooled by the intercooler 110 may be delayed and a temperature of the main combustion chamber 136 be maintained within the temperature range. Since the compound may be premixed with the gaseous fuel, the gaseous fuel may be ignited and combusted at the same time following a homogenous charge compression ignition (HCCI) principle, in turn resulting in relatively fast, consistent, and stable combustion. The method ends at step 304. Because a rate of rise of cylinder pressure in HCCI combustion may be higher than in regular diesel combustion, a rate of rise of cylinder pressure (i.e. within cylinder 128 of the engine 102) due to HCCI combustion may be controlled by relatively high levels (or rates) of EGR, and/or by running leaner air-fuel mixtures.

A load on the engine 102, in situations where there is only a given/fixed amount of the compound for example, may be controlled by changing an EGR rate and or the air-fuel ratio, or by controlling both the EGR rate and the air-fuel ratio. Further, by use of the compound, a need and/or a burden to use encapsulated spark plugs, multi-torch spark plugs, and/or pre-chamber engine design, is effectively avoided. This helps in a reduction of engine bulk and commensurate costs. Also, as a result, a durability concern associated with the encapsulated spark plugs/pre-chamber engine design is well addressed, and a need for providing a relatively high temperature combustion in a separate small chamber of the engine 102, to generate radicals, may be well avoided. Instead, it may be appreciated that the present disclosure relies on a relatively medium temperature reaction to generate radicals from a dissociation of the compound (i.e. H₂O₂ to OH radicals at approximately 900 Kelvin) near the top dead center (TDC), to facilitate combustion. Moreover, engine operational goals, including the reduction of emissions, such as of Nitrogen Oxide (NOx) during engine operation, may be more easily attained. On occasions when an engine with a pre-chamber engine design is applied, the compound may be introduced into the pre-chamber for facilitating combustion.

It should be understood that the above description is intended for illustrative purposes only and is not intended to limit the scope of the present disclosure. Thus, one skilled in the art will appreciate that other aspects of the disclosure may be obtained from a study of the drawings, the disclosure, and the appended claim.

What is claimed is:

1. A method to ignite a gaseous fuel in an engine of an engine system, the method comprising:
introducing a compound having a peroxide group into a main combustion chamber of the engine for igniting the gaseous fuel; and
controlling, by a controller, one or more parameters of the engine system to attain a temperature in the main combustion chamber within a temperature range, wherein
the compound decomposes into a radical, thus facilitating ignition of the gaseous fuel.

2. The method of claim 1, wherein the radical is a hydroxyl (OH) radical.

3. The method of claim 1, wherein the compound is Hydrogen Peroxide (H₂O₂)

4. The method of claim 1, wherein the gaseous fuel is natural gas.

5. The method of claim 1, wherein the engine system includes at least one cooler configured to cool a quantity of air delivered to the main combustion chamber for combustion, wherein the one or more parameters of the engine system include an outlet temperature of the at least one cooler.

6. The method of claim 1, wherein the engine system includes one or more valves adapted to at least one of: regulate an entry of the gaseous fuel into the main combustion chamber, and regulate an exit of residual gases of combustion out of the main combustion chamber, wherein the one or more parameters of the engine system include a timing of opening and closing of the one or more valves.

7. The method of claim 1 further comprising progressively varying an amount of the compound introduced into the main combustion chamber from a lesser amount to a higher amount to attain progressively shorter combustion timings of the gaseous fuel.

8. The method of claim 7, wherein the higher amount is 5% of a combined amount of the compound and the gaseous fuel.

9. The method of claim 1, wherein the temperature range is defined between 900 Kelvin to 1000 Kelvin.

10. An engine system, comprising:
an engine having a main combustion chamber adapted to receive a compound having a peroxide group for igniting a gaseous fuel; and
a controller configured to control one or more parameters of the engine system to attain a temperature in the main combustion chamber within a temperature range, wherein
the compound decomposes into a radical within the temperature range and facilitates ignition of the gaseous fuel.

11. The engine system of claim 10, wherein the radical is a hydroxyl (OH) radical.

12. The engine system of claim 10, wherein the compound is Hydrogen Peroxide (H₂O₂).

13. The engine system of claim 10, wherein the gaseous fuel is natural gas.

14. The engine system of claim 10 further including at least one cooler configured to cool a quantity of air delivered to the main combustion chamber for combustion, wherein the one or more parameters of the engine system include an outlet temperature of the at least one cooler.

15. The engine system of claim 10 further including one or more valves adapted to at least one of: regulate an entry of the gaseous fuel into the main combustion chamber, and regulate an exit of residual gases of combustion out of the main combustion chamber, wherein the one or more parameters of the engine system include a timing of opening and closing of the one or more valves.

16. The engine system of claim 10, wherein the controller is configured to control and progressively vary an amount of the compound introduced into the main combustion chamber from a lesser amount to a higher amount to attain progressively shorter combustion timings of the gaseous fuel, wherein
the higher amount is 5% of a combined amount of the compound and the gaseous fuel.

17. The engine system of claim 10, wherein the temperature range is defined between 900 Kelvin to 1000 Kelvin.

18. A method for operation of a natural gas engine of a natural gas engine system, the method comprising:
introducing hydrogen peroxide (H₂O₂) into a main combustion chamber of the natural gas engine for igniting natural gas; and
controlling, by a controller, one or more parameters of the natural gas engine system to attain a temperature in the main combustion chamber within a temperature range of 900 Kelvin to 1000 Kelvin, wherein the H₂O₂ decomposes into a hydroxyl (OH) radical within the temperature range, facilitating ignition of the natural gas.

19. The method of claim 18, wherein
the natural gas engine system includes at least one cooler configured to cool a quantity of air delivered to the main combustion chamber for combustion, wherein the one or more parameters of the natural gas engine system includes an outlet temperature of the at least one cooler; and
the natural gas engine system includes one or more valves adapted to at least one of: regulate an entry of the natural gas into the main combustion chamber, and regulate an exit of residual gases of combustion out of the main combustion chamber, wherein the one or more parameters of the natural gas engine system include a timing of opening and closing of the one or more valves.

20. The method of claim 18 further comprising progressively varying an amount of H₂O₂ introduced into the main combustion chamber from a lesser amount to a higher amount to attain progressively shorter combustion timings of the natural gas, wherein
the higher amount is 5% of a combined amount of the H₂O₂ and the natural gas.
